(19) United States
(12) Patent Application Publication
(10) Pub. No.: US 2002/0111201 A1
(43) Pub. Date: Aug. 15, 2002

(54) Location-based game system

(76) Inventor: Brook W. Lang, Issaquah, WA (US)

Correspondence Address: Dean A. Craine, DEAN A. CRAINE, P.S., 400 112th Avenue NE, Suite 140, Bellevue, WA, 98004-5542, US

(21) Appl. No.: 10/075,215

(22) Filed: Feb. 12, 2002

Related U.S. Application Data
(60) Provisional application No. 60/268,594, filed on Feb. 13, 2001.

(51) Int. Cl. A63F 13/00

(52) U.S. Cl. 463/2; 434/11

(57) ABSTRACT

A location-based game system for players over a wide region that uses location information transmitted from their wireless devices to a wide area computer network. Information from the wide area computer network can be downloaded to other players to determine the physical location of the players participating in the game. The location-based game system includes a location-based game software program preferably loaded into the memory of a central computer coupled to the wide area computer network that control the game and monitors the action and location of the players. During the game, data from each wireless device is uploaded to a player databank on the central computer. In one embodiment, each player wears a laser beam activated sensor at which their opponents shoot. Each sensor is coupled to a wireless device that uploads the number of “hits” recorded by the sensor to the wide area computer network. A central computer records the number of hits recorded by the sensor. In other embodiments, the location-based software game is loaded into the memory of the wireless device. In both embodiments, other players or authorized viewers are able to log onto the central computer to review the game status information that may include the user's location information in his or her database.

This a utility patent application based on the provisional patent application (60/268,594) filed on Feb. 13, 2001.

### BACKGROUND OF THE INVENTION

1. Field of the Invention

This invention relates to tag-like games played by two or more individuals, and, more particularly, to such games that enable players to record and receive location information regarding their opponents over a wide area region.

2. Description of the Related Art

Laser tag is a competitive, location-based game between two or more players located in the same vicinity where players shoot a laser-generated, low-power light beam produced by a laser beam transmitter at a laser beam sensor or detecting unit worn by his or her opponent. When a pre-determined number of “hits” are recorded by the sensor, a visual or audible alarm is activated informing him or her that they have been “killed”. Examples of laser beam transmitters and receivers are available from Laser Runner Laser Tag Supplies of Alberta, Canada.

Web-based wireless telephones are now available that enable users to transmit data or a wide area computer network to send and receive data from telephones or other devices connected to the network. Some wireless telephones also include built-in GPS receivers that enable the telephone user to determine his or her physical location.

What is needed is a location-base game system for two or more players located in a large region that uses location information of at least one player's wireless telephone that is transmitted over a wide area network to other players or viewers.

### SUMMARY OF THE INVENTION

It is an object of the present invention to provide a location-based game system in which the players move in a large region.

It is another object of the present invention to provide such a game system that uses a wireless telephone or similar device that is able to connect to a wireless communication network and transmit and receive digital data from a wide area computer network.

It is a further object of the present invention to provide such a game system that monitors the location of at least one player and then makes this information available to opponents or authorized viewers connected to the wide area computer network.

These and other objects are met by a location-based game disclosed herein wherein the location and status or condition of the players are monitored by opponents or viewers. More specifically, each player operates a wireless telephone or similar device in a region with continuous wireless telephone network service. Each wireless telephone or device is able to transmit and receive digital information from a wide area network linked to the wireless communication network. Each wireless telephone or device includes or is connected to a physical location means used to establish the user's exact physical location at any time in the region. In one embodiment, the wireless telephone circuitry and physical location means are assembled into a single device, such as a GPS enhanced cellular telephone, or assembled in separate units, coupled together via wired or wireless links. Using the wireless telephone or device, the player intermittently or continuously upload his or her identification information and physical location information to the wide area computer network. The wireless telephone or device may be also used to download instructions or other data from a central server or other wireless telephone or devices operated by other players.

In the preferred embodiment of the game system, wireless telephones or devices are also assigned to other players so that each player can connect to the wide area computer network and download data from the central computer. Such data may include the other player's identity, the exact location of all of some of the players participating in the game, and movement history.

One example of a location-based game that can be played is laser tag wherein each player wears a laser tag sensor that is coupled to the user's wireless telephone. During use, the wireless telephone or device is continuously or intermittently connected to the wide area network. Packets of identity, date, time, and location information is transmitted intermittently or continuously from the wireless telephone device to a central computer connected to the wide area network. In laser tag, the number of hits are recorded by the sensor coupled to the wireless telephone or device and immediately or intermittently uploaded to the central computer. When a selected number of “hits” is recorded on the sensor, the sensor indicates that the player has been “killed”. Upon receipt of the uploaded information from each player, the central computer stores the information into the player's database. A game software loaded into the central computer, collects the information in each player database to provide updated information on all of the players. During the game, the status or condition, and location of each player may be reviewed by the other players or by authorized viewers who log into the central computer.

### BRIEF DESCRIPTION OF THE DRAWINGS

FIG. 1 is an illustration showing the transmitter device and sensor in prior art.

FIG. 2 is a schematic of the continuous location-based game.

### DESCRIPTION OF THE PREFERRED EMBODIMENT(S)

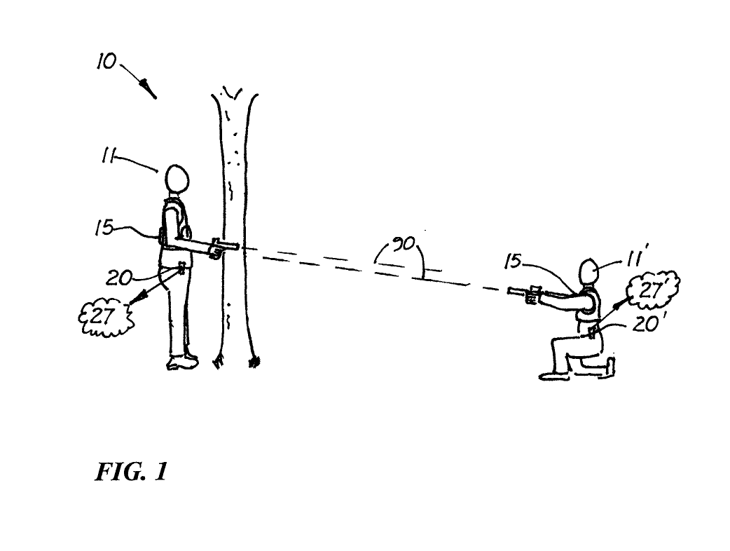

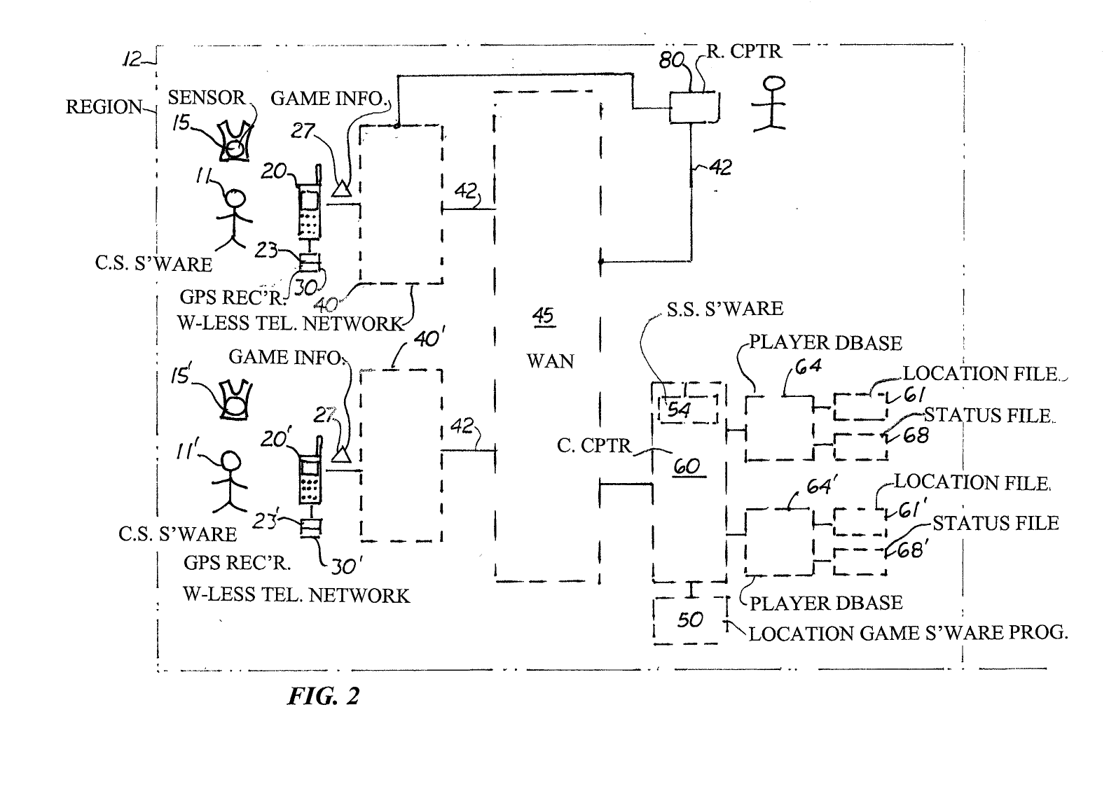

In FIGS. 1-2, a location-based game system 10 is shown being played, designed to enable players 11, 11′ located anywhere in a large region 12 to play a location-based software game 50 anywhere within a large region 12. The system 10 allows the player 11, 11′ or authorized viewers to monitor the status of the game and the location of the players 11, 11′ anywhere within the region 12. The identity, location and game-related information, hereinafter called game information 27, 27′ is transmitted to a wireless communication network 40 and eventually to a wide area computer network 45. A central computer 60 is connected to a wide area computer network 45 with a game software program 50 loaded into its memory monitors and controls the game process and the uploading and downloading of data. The game software program 50 also creates player's database 64, 64′ which contains current game status and location files 61, 61′, 68, 68′ respectively, which can be immediately or later reviewed.

As an representative example, FIGS. 1 and 2 depict the game system 10 that includes a tag recording sensor 15, such as a laser sensor carried or worn by the user 11 and coupled to a web-based wireless telephone 20. The sensor 15 is a small, battery-operated laser transmitter capable of generating a low-level laser beam 90.

The sensor 15 connects to the wireless device 20, such as a data network enabled wireless telephone. The wireless device 20 transmits the game information 27 from the sensor 15 over a wireless communication network 40, 40′ to a central computer 60 connected to a wide area network 45. A land-based communication link 42 may be used to connect the wireless communication system 40 to the wide area network 45. The central computer 60 collects the user's uploaded game information 27 from the sensor 15 whenever the wireless telephone 20 is connected to the wide area network 45. The user's game information 27 is then stored in the player's database 64, 64′ created by the central computer 60. Remote computers 80 may be connected to the wide area network 45 via the wireless computer network 40 or landline telephone network 42 to upload and download information in the player's database 64, 64′ from the central computer 60.

It should be understood that the sensor 15 can be a built-in component on the wireless device 20 or a separate unit coupled to the wireless device 20 via a wired or wireless connection link. When the wireless device 20 and sensor 15 are separate devices, the wired connection means could be replaced with a local wireless connection means. One type of local area wireless connection means designed to connect electronic devices is available under the wireless connection system sold under the trademark Blue Tooth from Telefonaktiebolaget LM Ericsson, which is now incorporated herein. p Each wireless device 20 is designed to continuously, or intermittently, upload the game information 27 to the central computer 60 so that the player's information database 64 is constantly and immediately updated. In an optional embodiment, the wireless device 20 includes a physical location-detecting means that determines the user's specific physical location at the time the game information 27 is collected, or at the time the wireless device 20 is connected to the wide area network 45. The physical location means is a global positioning system (GPS) receiver 30. The GPS receiver 30 is able to immediately establish the monitoring device's global position, (i.e. latitude, longitude, elevation), heading, and velocity.

The GPS is a location system based on a constellation of twenty-four satellites orbiting the Earth at altitudes of approximately 11,000 miles. The GPS satellites provide accurate positioning information twenty-four hours per day, anywhere in the world. The GPS uses a receiver that stores orbit information for all GPS satellites. During use, the receiver determines the time and the positions of the overhead satellites and then calculates the amount of time it takes a GPS radio signal to travel from the satellites to the receiver. By measuring the amount of time it takes for a radio signal to travel from the satellites, the exact location of the GPS receiver can be determined. GPS receivers 30 are available from Corvallis Microtechnology, Inc., in Corvallis, Oreg. It should be understood however, that other means for automatically determining the user's physical location could be used.

The game 10 uses GPS receivers 30 that are 3-D coordinate receivers that require a minimum of four visible satellites. It should be understood, however, that the game 10 could be used with 2-D coordinate receivers, which require a minimum of three satellites. The 3-D coordinate receivers are preferred, since they will continue to provide 2-D coordinate information when trees, mountains, buildings, etc. obstruct their views.

When the GPS receiver 30 is turned on, it immediately provides a “fix” position. As it continues to operate, it records “waypoints” at pre-determined intervals (i.e. 1-5 seconds). A client-side software program 23, discussed further below, is designed to receive the “fix” and “waypoints” coordinates and transmit them to the central computer 60 as part of the game information 29.

Loaded into the memory of each wireless device 20 is a client-side software program that enables the wireless device 20 to communicate with a server software program 54 loaded in the central computer 60. During use, the client-side software program 23 collects the number of hits, the time, and the location information and uploads it to the central computer 60. Also, when a player 11 initially logs into the central computer 60, the client-side software program 23 transmits the player's identification information, such as the player's name and password, so that the player 11 may access the game program and his or her files 61, 68 in his or her database 64.

As discussed above, the central computer 60 is able to communicate via the wide area network 45 with a plurality of sensors 15 all connected to the wide area network 45 via the cellular telephone network 40. It should be understood that the central computer 60 may be one server or a group of servers all connected to the wide area network 45. As discussed above, loaded into the memory of the central computer 60 is the server-side software program 54 capable of uploading and processing data from the client-side software program 23. The server-side software program 54 is also used to handle requests from the client-side software program 23 and download requested datafiles 61, 68 to the wireless device or the remote computer 80.

In order to participate in the game 10, the player's wireless device or remote computer's network address must be known to the central computer 60 so that information contained in the user's files 61, 68 may be downloaded thereto. If the central computer 60 is also the authorized user's network service provider to the wide area network 45 and a previously established account has been set up on the central computer 60, the numerical or temporary address would be known to the central computer 60 when the player 11 signs onto the central computer 60. If the player 11 does not have a previously established account on the central computer 60, then the client-side software program 23 must be used to collect and transfer the account information to the central computer 60 each time the player 11 logs onto the central computer 60.

During use, the player's personal information is entered into the client-side software program 23. When initial contact is made with the central computer 60, the personal information is automatically downloaded to the central computer 60. The client-side software program 23 may be a proprietary software program, or may be included as an add-on to an existing INTERNET browser software program. After the account information has been confirmed or set up on the central computer 60, the player 11 may begin to download and/or upload information from the central computer 60.

The location-based game system 10 described above may be used with other game software programs 50 loaded either into the central computer or the wireless devices 20, 20′ depending on the complexity of the game and the hardware resources required to play the game. For example, the game software program 50 could be a treasure hunt game in which players attempt to find the location of a hidden treasure. The game software program 50 would be programmed to provide clues to the players 11, 11′ that would be downloaded to the wireless devices 20, 20 at selected intervals. When the player's reach a selected location, another clue could be provide to each player until one player reaches the treasure. During the course of the game, the player's 11, 11′ and authorized viewers could monitor the location of each player to determine whether they are approaching or have arrived at the treasure.

In compliance with the statute, the invention, described herein, has been described in language more or less specific as to structural features. It should be understood, however, the invention is not limited to the specific features shown, since the means and construction shown comprise only some of the preferred embodiments for putting the invention into effect. The invention is, therefore, claimed in any of its forms or modifications within the legitimate and valid scope of the amended claims, appropriately interpreted in accordance with the doctrine of equivalents.

I claim:

1. A location-based game system, comprising:
a. a wireless communication network capable of transmitting digital information;
b. at least one wireless device capable of transmitting and receiving digital information from said wireless communication network, each said wireless telephone being assigned to at least one player;
c. a physical location means coupled to said wireless device used to determine and transmit the physical location of said player over said wireless communication network;
d. a wide area computer network coupled to said wireless communication network to enable the physical location of said player to be uploaded from said wireless communication network, and;
e. a location-based software game that uses the location information from each said player to achieve the object of the game.

2. The location-based game system, as recited in claim 1, wherein said location-based software game is located the memory of said wireless device.

3. The location-based game system, as recited in claim 1, further including a central computer connected to said wide area network.

4. The location-based game system, as recited in claim 1, wherein said location-based software game is located into the memory of said central computer.

5. The location-based game system as recited in claim 4, wherein said location-based software game is a laser tag game that monitors and records the number of hits of a laser beam generated by a laser been transmitter on a laser beam receiver.

6. The location-based game system, as recited in claim 5, wherein said central computer includes a database file for said player to record the location of said player.

7. The location-based game system, as recited in claim 5, further including a laser beam sensor coupled to said wireless device, said laser beam sensor used to detect a laser beam from a laser transmitter.

8. The location-based game system as recited in claim 7, wherein said location-based software game is a laser tag game that monitors and records the number of hits of a laser beam generated by said laser been transmitter on said laser beam receiver.

9. The location-based game system, as recited in claim 1, further including a client-side software program loaded into said wireless device and a server side software program loaded into said central computer to enable said wireless device to communicate with said central computer over said wide area network.

10. The location-based game system, as recited in claim 5, wherein the object of said location based software game is to find a selected target by said players.

11. The location-based game system, as recited in claim 10, wherein said target is selected by said central computer.

12. The location-based game system, as recited in claim 10, further including means to transmit clues to said player to find said target.
